(19) United States
(12) Patent Application Publication
(10) Pub. No.: US 2010/0001530 A1
(43) Pub. Date: Jan. 7, 2010

(54) "Sandwich" multiple hydro turbine power driver technology

(76) Inventor: Nelson N.S. Chang, Flushing, NY (US)

Correspondence Address: Nelson N.S. Chang, 154-40 Horace Harding Expressway, Flushing, NY, 11367, US

(21) Appl. No.: 12/454,165

(22) Filed: Aug. 14, 2009

Related U.S. Application Data
(60) Provisional application No. 61/058,225, filed on Jun. 3, 2008.
(60) Provisional application No. 61/058,226, filed on Jun. 3, 2008.

(51) Int. Cl. F03B 13/10

(52) U.S. Cl. 290/54; 415/60

(57) ABSTRACT

A multiple hydro turbine power concept, basically an efficient hydrokinetic (energy by the movement of water) energy conversion system comprising a shrouded stage multiple turbines. Mechanical power is applied directly through a speed increaser to a generator. The water for multiple turbines discharges throughout a group of bail jet nozzles in the low pressure region behind the cup. The accelerated flow in the nozzle pushes the turbine directly driving an electrical generator.

### RELATE APPLICATIONS

This application is subject to US provisional application Ser. No. 61/058,225 filed 3 Jun. 2008 and US provisional application Ser. No. 61/058,226 filed 3 Jun. 2008.

Please incorporate by reference all information in said provisional applications into this instant invention.

### BACKGROUND OF THE INVENTION

### Field of the Invention

The present invention relates generally to hydrokinetic energy conversion. and, more specifically, to a multiple hydro turbine power concept, basically an efficient hydrokinetic (energy by the movement of water) energy conversion system comprising a shrouded or enshrouded multitude of turbines. Mechanical power is applied directly through a speed increaser to a generator. The water for multiple turbines discharges throughout, in the low pressure region behind the shroud.

The accelerated flow through the bail jet nozzle pushing the turbine Directly drive an electrical generator. Additionally a different gear control box May be implemented on the turbines driving shaft that can fulfill all the purposes of powered work and utilities.

The device generates electricity while directly submerged below the ocean surfaces or river currents and waterfalls. eliminating the need of a dam or water reservoirs. Significant power can be generated when many of the devices are clustered together in line (as a farm) forming a group of generating units. Each device will ultimately be hooked with a metal chain or flexible cable in stable position, buoyed beneath the water's surface and/or permanently fixed in a location. Because ocean and river water surface altitude level always changes, the buoyed object must have a moving space for the device, up and down with the moving water.

For maintenance, the device(s) can be towed to shore, also it can be disassembled. The electronic controlling modules are locked on shore designed to match the device's electrical output to accept small 3 to 15 kW unit that can be inter faced to home electric circuit line or up to 300 kW units for connection to the electric grid. The turbine can be anchored on the bottom by concrete plates or attached on or to a floating platform such as a barge or attached to existing structures such as a bridge. New fixed installations can be utilized anywhere, controlling modules are on shore and would match AP&T's grid as to voltage, hertz and phases, at all times. The amperage would be variable, because of the variable velocity of the flowing water resources. The modules are designed to insulate the AP&T's system for an equipment malfunction by a cutout within six milliseconds. The state of the art generators are light, efficient and variable speed design with an available output from 3 to 300 kW. These turbines can be manufactured in thermoplastic or in fiberglass with a strong metal screen inside. The are modular in design and easy to deploy.

The turbine can be placed approximately a few feet below the water's surface and a reasonable distance from shore. Anchors would be set first and turbine unites attaché in a stable position facing the water current flow. As soon as the unit enters the water it will begin generating electricity. From the shore, an operator can command this unit to have highest efficiency position.

### SUMMARY OF THE PRESENT INVENTION

A primary object of the present invention is to provide a multiple hydro turbine power concept, basically an efficient hydrokinetic (energy by the movement of water) energy conversion system comprising a shrouded stage multiple turbines employed for all utility purposes.

Another object of the present invention is to provide a multiple hydro driven power driver (MHTPD) where mechanical power is applied directly through a speed increaser or generator. The water for a group of bail jet nozzles having tremendous pushing power on the multiple turbines turning the driving shaft generates electricity or uses the differential gear control box for all types of utilities.

Yet another object of the present invention is to provide a device that generates electricity while directly submerged many feet below the ocean surfaces or a river using currents, eliminating the need of a dam.

Still yet another object of the present invention is to provide significant. power, that can be generated when many of the devices are clustered together in line (as a farm) forming group generating units or installed anywhere that devices cannot be suitable installed due to low water or current flow.

Another object of the present invention is to provide that each device be ultimately hooked with a metal chain, flexible cable or suitable tether in a stable position, buoyed beneath the water's surface.

Yet another object of the present invention is to provide for being anchored on the bottom by concrete plates or on a floating platform such as a barge or attached to existing structures such as a bridge.

Still yet another object of the present invention is to provide for the turbine placement a few feet approximately below the water's surface the fastest water flow speed and a reasonable distance from shore. Anchors would be set first and turbine units would stay in a stable position facing the water current flow. As soon as the unit enters the water it will begin generating electricity. From the shore, an operator can command this unit to have the highest efficiency position.

Additional objects of the present invention will appear as the description proceeds.

The present invention overcomes the shortcomings of the prior art by providing a multiple hydro turbine power concept, basically an efficient hydrokinetic (energy by the movement of water) energy conversion system comprising a shrouded stage multiple turbines. Mechanical power is applied directly through a speed increaser to generator. The water for multiple turbines discharges throughout a group of bail jet nozzles in the low pressure directly driving an electrical generator. The turbine will be positioned approximately a few feet below the water's surface the fastest of water flow and a reasonable distance from shore utilizing a fixed installation or anchors would be set first and turbine units would stay in a stable position facing the water current flow. As soon as the unit enters the water it will begin generating electricity or working for utilities. From the shore, an operator can command this unit to have highest efficiency position.

The foregoing and other objects and advantages will appear from the description to follow. In the description reference is made to the accompanying drawings, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to accompanying drawing in which:

FIG. 1 is a disassembled component view of the present invention;

FIG. 2 is a disassembled component view of the present invention;

FIG. 3 is a sectional view of the present invention;

FIG. 4 is a schematic view of an element of the present invention;

FIG. 5 is a sectional view of gear fox of the present invention;

FIG. 6 is an illustrative view of the present invention;

FIG. 7 is an exploded view of the water turbine casing of the present invention;

FIG. 8 is an exploded component view of the present invention;

FIG. 9 is an illustrative view of the present invention;

FIG. 10 is an illustrative view of the present invention;

FIG. 11 is an illustrative view of the present invention; and

FIG. 12 is an illustrative view of the present invention.

### DESCRIPTION OF THE REFERENCED NUMERALS

Turning now descriptively to the drawings, in which similar reference characters denote similar elements throughout the several views, the figures illustrate the Multiple Hydro Generator System of the present invention. With regard to the reference numerals used, the following numbering is used throughout the various drawing figures.
10 Multiple Hydro Generator System of the present invention
12 housing
14 turbine cover plate
16 cup mounting plate
18 turbine cup
20 cup mounting plate
22 sandwich
24 generator case
26 generator
28 wire cable
30 centrifugal spinner
32 generator drive shaft
34 drive shaft mounting
36 drive shaft
38 control case
40 generator gear
42 vacuum gear
44 grinding machine gear
46 water pump gear
48 air pump gear
50 eater inlet
52 metal screen
54 mounting frame
56 drum extension
58 mounting ring
60 mounting plate
62 adapter
64 extension water drum
66 water outlet
68 generator
70 cover pulley enforcement support
72 flotation
74 rack stand
76 outlet water adapter
78 bail jet water cone

### DETAILED DESCRIPTION OF THE PREFERRED EMBODIMENT

The following discussion describes in detail one embodiment of the invention (and several variations of that embodiment). This discussion should not be construed, however, as limiting the invention to those particular embodiments, practitioners skilled in the art will recognize numerous other embodiments as well. For definition of the complete scope of the invention, the reader is directed to appended claims.

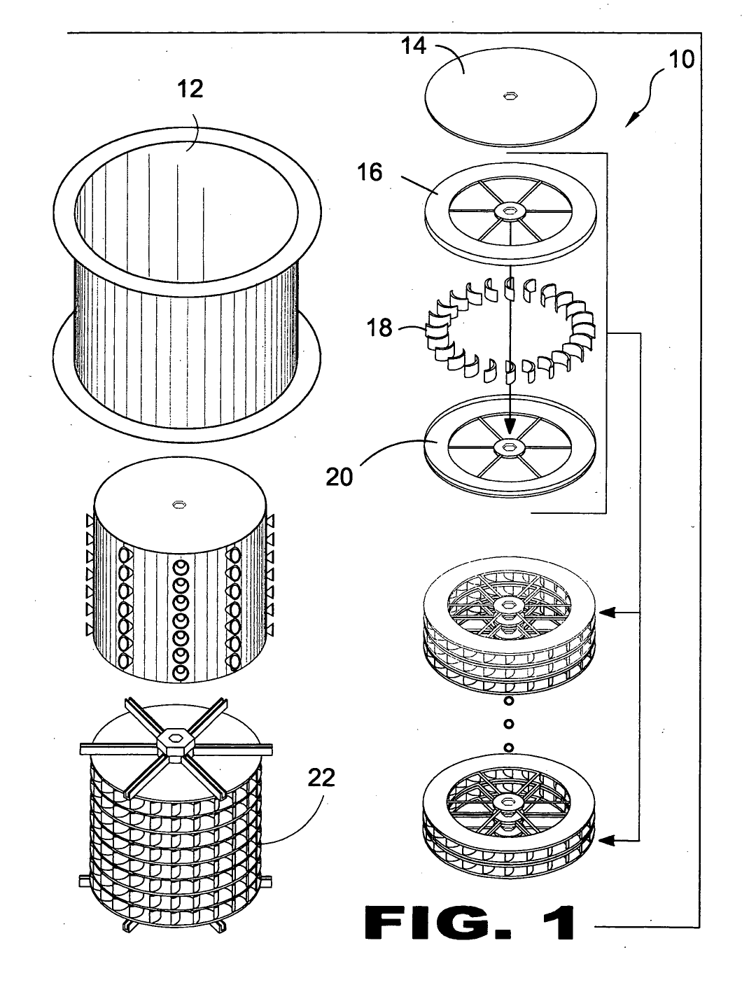

FIG. 1 is a disassembled view of the present invention 10. Shown is the disassembled components of the (MHTPD) or Multiple Hydro Turbine Powerful Driver of the present invention. The present invention is utilized to generate electricity while submerged in water or under mountain water falls. Shown are the housing 12, the turbine cover plate 14, the cup mounting plate 16, the turbine cups 18, the cup mounting plate 20 and the Sandwich 22.

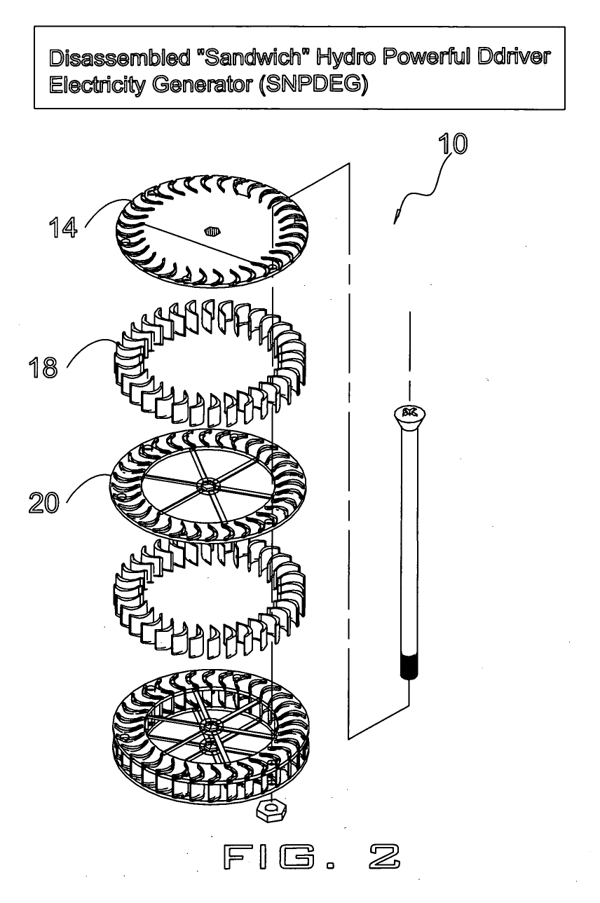

FIG. 2 is a disassembled component view of the present invention 10. Shown are the disassembled component of the (MHTPD) of Multiple Hydro Turbine Powerful Driver 10 of the present invention. The present invention is utilized to generate electricity while submerged in water or under mountain water falls. Shown are the turbine cover plate 14, turbine cups 18 and the cup mounting plate 20.

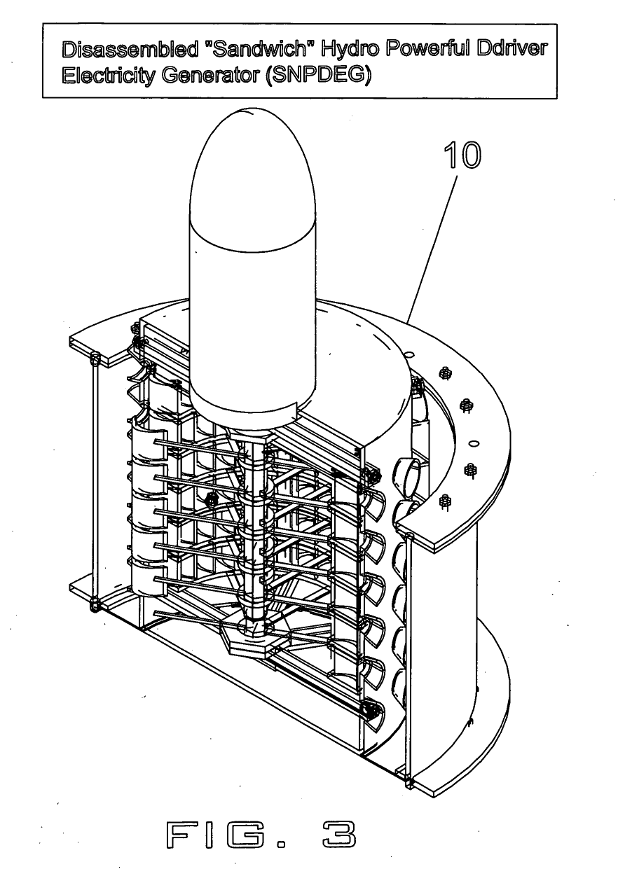

FIG. 3 is a sectional view of the present invention 10. Shown is the disassembled components of the (MHTPD) or Multiple Hydro Turbine Powerful Driver 10 of the present invention. The present invention is utilized to generate electricity while submerged in water or under mountain water falls.

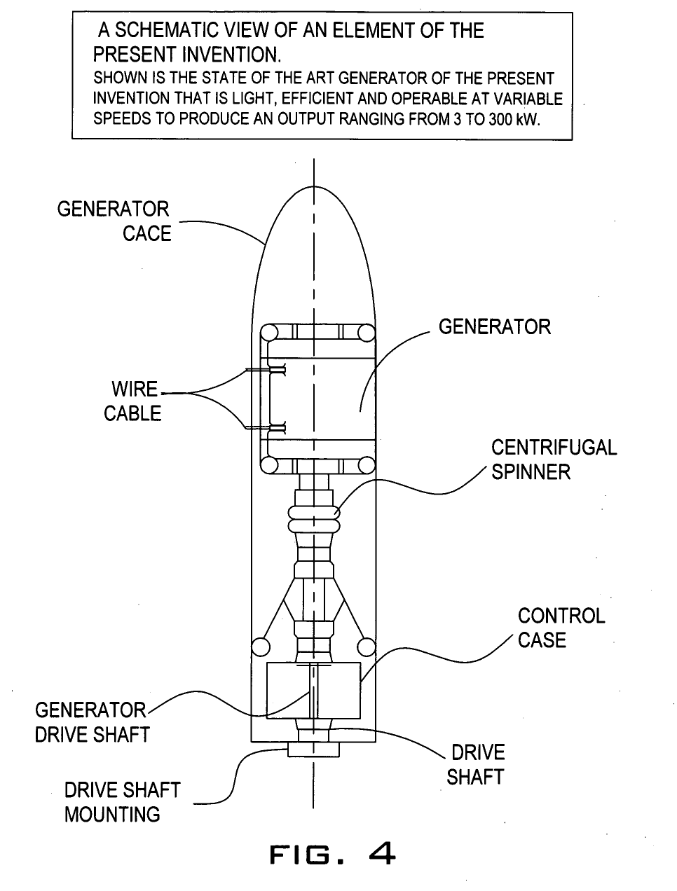

FIG. 4 is a schematic view of an element of the present invention. Shown id the state of the art generator of the present invention that is light, efficient and operable at variable speeds to produce an output ranging from 3 to 300 kW. Depicted in the illustration are the generator case 24, the generator 26, the wire cable 28, the centrifugal spinner 30, the generator drive shaft 32, the drive shaft mounting 34, the drive shaft 36, and the control case 38.

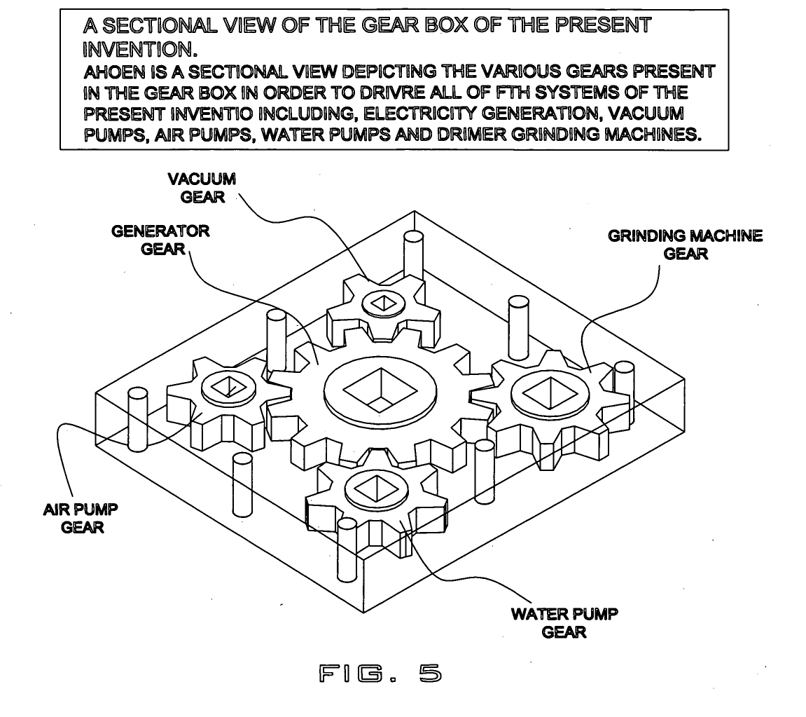

FIG. 5 is a sectional view of the gear box of the present invention 10. Shown is a sectional view depicting the various gears present in the gear box in order to drive all of the systems of the present invention including, electricity generation 40, vacuum pumps 42, air pumps 48, water pumps 46, and driver grinding machines 44.

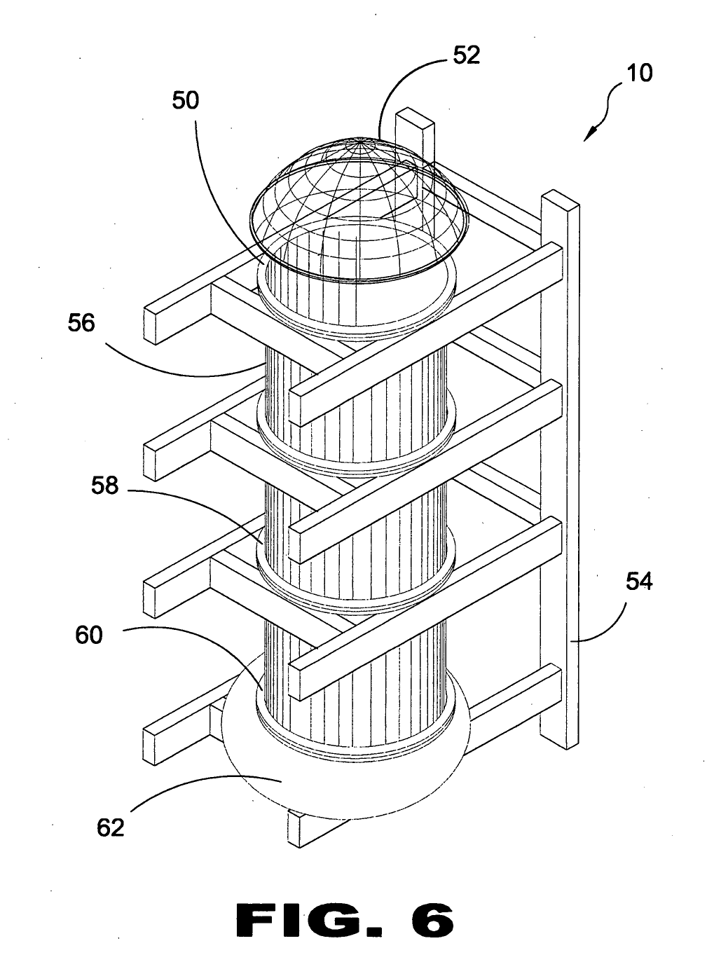

FIG. 6 is an illustrative view of the present invention 10 shown is an assembled view of a turbine that can be positioned in a water stream to generate electrical power. Additionally shown is one of many methods of mounting the device to a rack, scaffolding or aquatic structure. This is a complete electricity generator with a state of the art generator and circuit control system preferably manufactured by AP&T Company, which is the first choice. Also it is the best one for the “sandwich” Multiple Hydro Turbine Power Driver on the market. The water inlet 50 is a wide open water inlet adapter to channel more water into the drum. The screen is a strong metal screen 52 to protect the machinery to avoid some big stuff and water creatures from getting inside and plugging the jet nozzles or killed by the rotors. The mounting frame 54 is for mounting the machinery up on mountain walls or any structures. The water drum extension 56 serves to hold drain water. Mounting rings 58 are strong metal flat plate rings welded to wire screen covered by fiberglass plastic drum sheet. A heavy mounting plate 60 with ball jet nozzle cone weld together is a major part of the machine. Also included is an adapter 62r to hold heavy machinery on it.

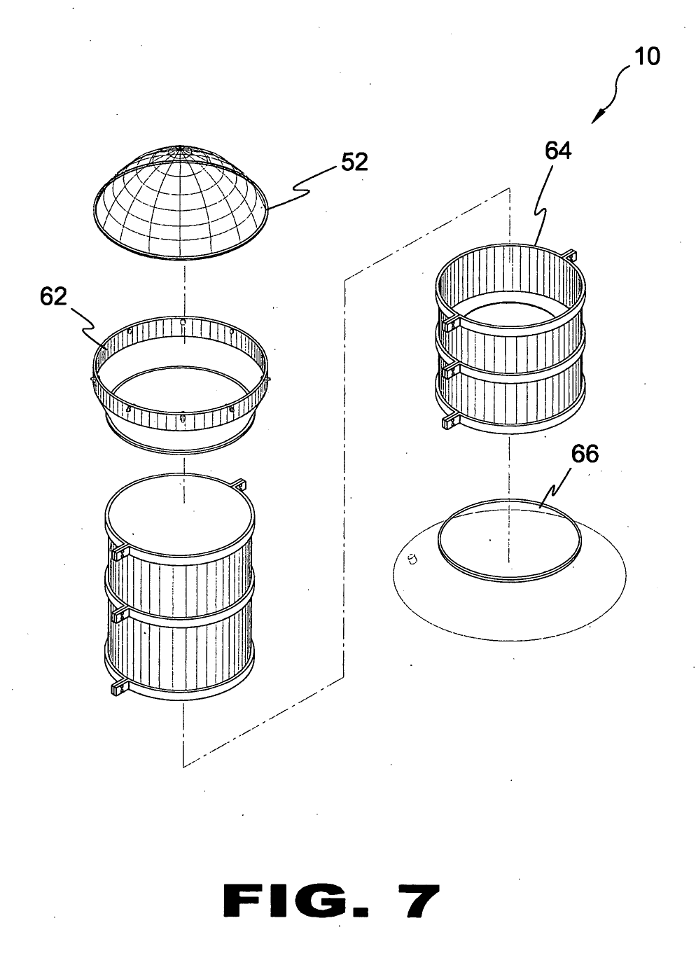

FIG. 7 is an exploded view of the water turbine casing of the present invention 10. Shown is an exploded view of the turbine casing that can be positioned in a water stream to generate electrical power. Additionally shown is the present invention having a screen cover 52 for preventing aquatic life forms from entering. Depicted is the adapter for water inlet 62, the extension water holder drum 64 and the water outlet duct 66.

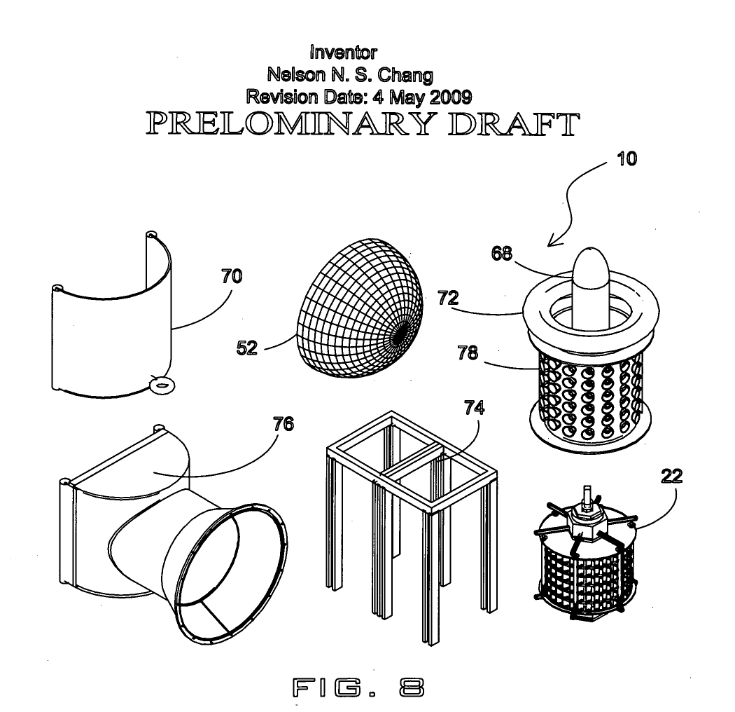

FIG. 8 is an exploded component view of the present invention 10. Shown is the tidal water flow “sandwich” Multiple Hydro Turbine Electricity Generator (SWG) set of the present invention broken down into its individual components that may be utilized on the ocean shore side in either a fixed or cable float installation. The generator 68 is a state of the art generator which is manufactured by the AP&T company. The cover has a pulley enforcement 70 support on it to cover both sides of the water inlet. The flotation 72 is filled with air for rising and falling. The rack stand 74 is a mounting for the water Electricity generator which has four steel post tracks, two round and two are rail tracks with both sides having deep tracks to hold covers and outlet water ducts. The outlet water adapter 76 is located on both sides of the tidal water rise and descend and wide open cup makes power suction for faster water discharge. Also shown are the assembled rotor 22 and the bail jet water cone 78.

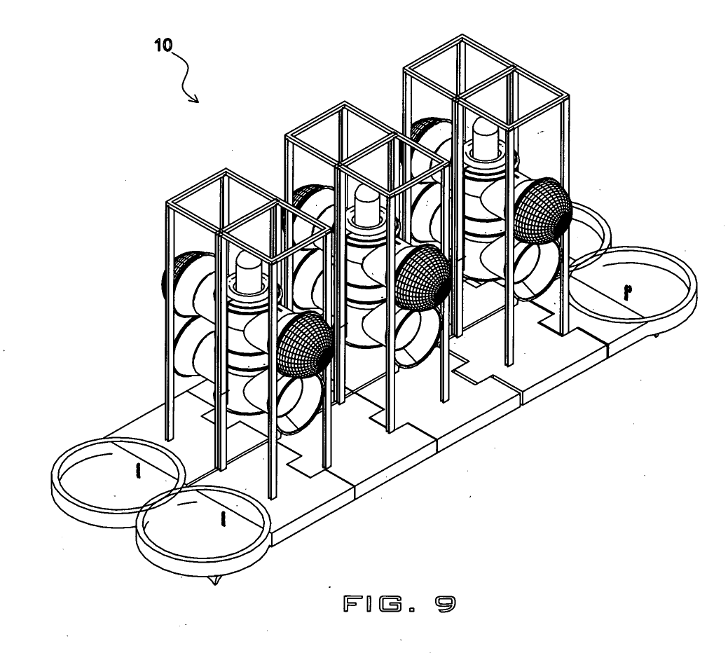

FIG. 9 is an illustrative view of the present invention 10. Shown is an illustrative view of the tide water generator of the present in invention in a fixed installation. The present invention 10 is mounted to the ground utilizing a plurality of concrete portions and steel rails protruding vertical there from.

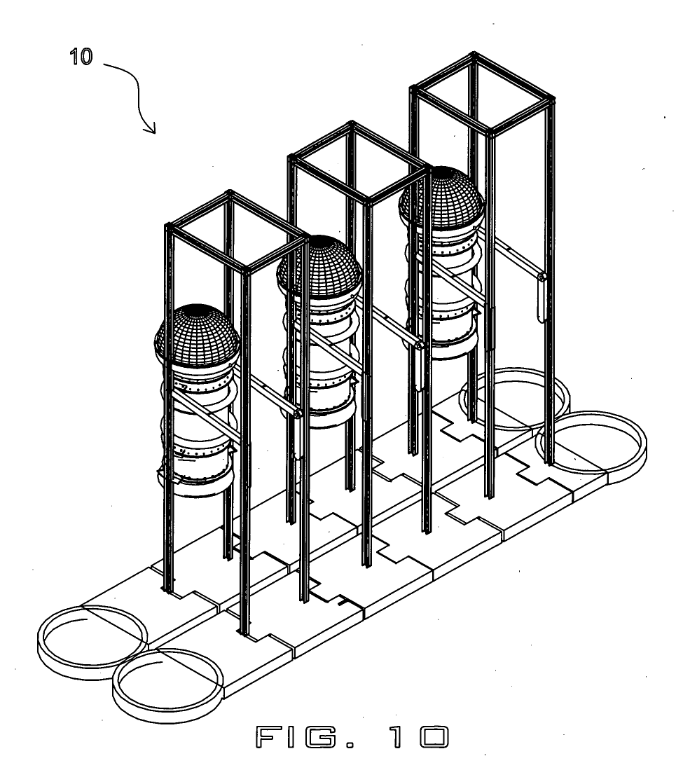

FIG. 10 is an illustrative view of the present invention 10. Shown is an illustrative view of the tide water generator of the present invention in a wave electricity generation installation. This is a drum extension to hold drain water.

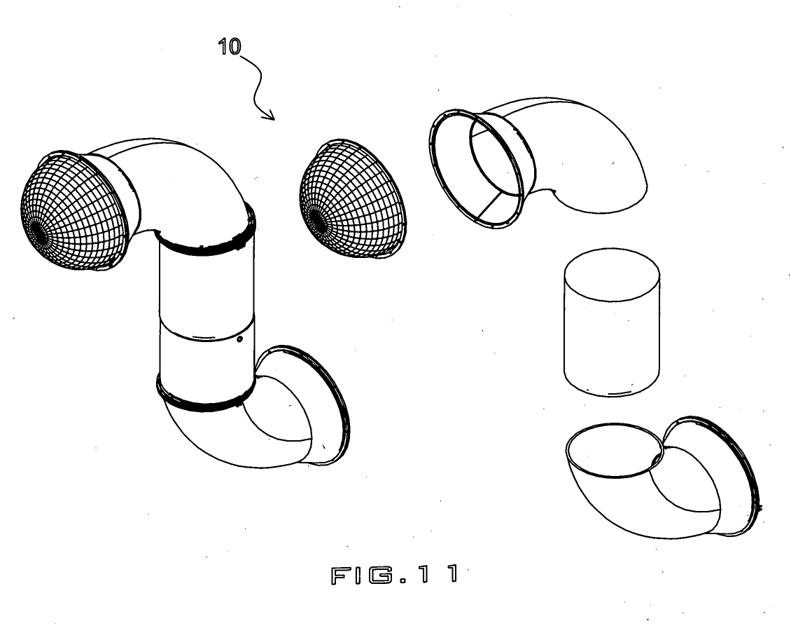

FIG. 11 is an illustrative view of the present invention 10. Shown is an illustrative view of the tide water generator of the present invention.

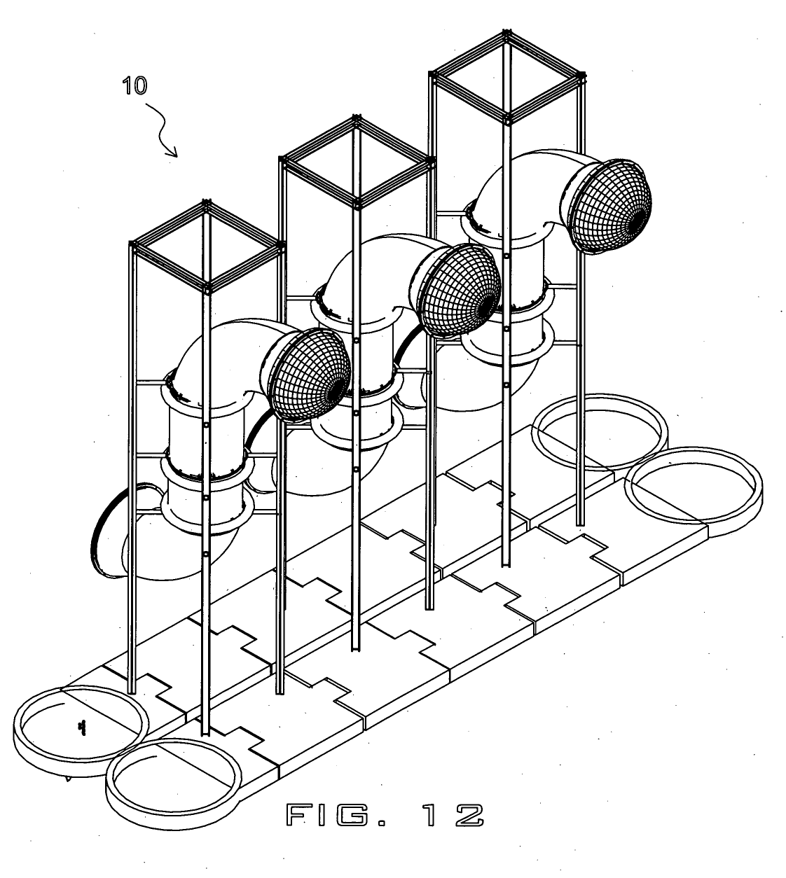

FIG. 12 is an illustrative view of the present invention 10. Shown is an illustrative view of the tide water generator of the present invention having a redirectable flow construction allowing any location with a water flow to supply a green power source.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gust of the present invention that others can, by applying current knowledge, readily adapt it for various applications without omitting features that, from the standpoint of prior art, fairly constitute essential characteristics of the generic or specific aspects of this invention.

What is claimed is new and desired to be protected by Letters Patent is set forth in the appended claims:

1. An apparatus for hydro kinetic energy conversion with a multiple hydro turbine system comprising:
a) a generator case;
b) a plurality of turbine clips;
c) a centrifugal spinner;
d) a generator drive shaft;
e) a drive shaft;
f) a drive shaft mounting; and
g) a drive shaft mounting.

2. An apparatus for hydro kinetic energy conversion with a multiple hydro turbine system according to claim 1, further including a turbine cover plate.

3. An apparatus for hydro kinetic energy conversion with a multiple hydro turbine system according to claim 2, further including a cup mounting plate.

4. An apparatus for hydro kinetic energy conversion with a multiple hydro turbine system according to claim 3, including a housing for a sandwich of turbine cover plates, cup mounting plates and turbine clips.

5. An apparatus for hydro kinetic energy conversion with a multiple hydro turbine system according to claim 4, further including a gear box.

6. An apparatus for hydro kinetic energy conversion with a multiple hydro turbine system according to claim 5, wherein said gear box includes a generator gear for driving a vacuum gear, a grinding machine gear, an air pump gear and a water pump gear.

7. An apparatus for hydro kinetic energy conversion with a multiple hydro turbine system according to claim 6, further comprising a water inlet.

8. An apparatus for hydro kinetic energy conversion with a multiple hydro turbine system according to claim 7, further including a drum extension to hold drain water.

9. An apparatus for hydro kinetic energy conversion with a multiple hydro turbine system according to claim 8, including heavy strong metal mounting plate rings welded to wire screen covered by fiberglass plastic sheet drum.

10. An apparatus for hydro kinetic energy conversion with a multiple hydro turbine system according to claim 9, further comprising a heavy mounting plate with bail jet nozzle con welded together.

11. An apparatus for hydro kinetic energy conversion with a multiple hydro turbine system according to claim 10, including an adapter to hold heavy machinery on it.

12. An apparatus for hydro kinetic energy conversion with a multiple hydro turbine system according to claim 11, including a mounting frame to hold the machinery on mountain walls and other like structures.

13. An apparatus for hydro kinetic energy conversion with a multiple hydro turbine system according to claim 12, wherein said apparatus is submerged underwater and is generated by the current of the water.

14. An apparatus for hydro kinetic energy conversion with a multiple hydro turbine system according to claim 13, wherein said apparatus is installed under a waterfall to generate the power there from.
